(19) United States
(12) Patent Application Publication
(10) Pub. No.: US 2014/0333537 A1
(43) Pub. Date: Nov. 13, 2014

(54) POINTING DEVICE WITH INTEGRATED KEYBOARD

(71) Applicant: Moon J. Kim, Wappingers Falls, NY (US)

(72) Inventor: Moon J. Kim, Wappingers Falls, NY (US)

(21) Appl. No.: 13/891,506

(22) Filed: May 10, 2013

(51) Int. Cl. G06F 3/0354

(52) U.S. Cl. CPC G06F 3/03543
USPC 345/163; 345/168

(57) ABSTRACT

A pointing device/mouse having a keypad integrated thereon. Other embodiments relate to a pointing device/mouse having a virtual keypad activation mechanism, which, when activated, causes a virtual keyboard to appear on a computer screen of a tablet or similar device.

### TECHNICAL FIELD

In general, embodiments of the present invention relate to input devices, namely, a pointing device/mouse having a keypad integrated thereon. Other embodiments relate to a pointing device/mouse having a virtual keyboard activation mechanism, which, when activated, causes a virtual keyboard to appear on a computer screen of a tablet or similar device.

### BACKGROUND OF THE INVENTION

Typically, a computer or other computerized device may receive input through a keyboard implemented either as hardware or virtually, for example, on a touch-sensitive computer screen. Typically, these are separate devices, or the mouse is placed somewhere on the keyboard, as a touch sensitive keypad or moveable stick, etc. As computers, tablets, smart phones, and other digital devices are becoming more and more prevalent in daily life, it is therefore desirable to have an improved apparatus and method for data input.

### SUMMARY OF THE INVENTION

Embodiments of the present invention provide a pointing device which integrates a mouse (having a position/movement-detecting mechanism) with a keypad/keyboard. In one embodiment, the keypad may be situated on a housing of a pointing device. In another embodiment, a virtual keypad may be activated on a computer screen by activation by a button or other mechanism present on a pointing device. In yet another embodiment, the pointing device comprises both a keypad situated on the housing thereof and an activation button for enabling the virtual keypad.

A first aspect of the present invention provides a pointing device, having a housing, a position detector, an interface, and a keypad.

A second aspect of the present invention provides a pointing device, having a housing, a position detector, an interface, and a virtual keypad activation mechanism.

A third aspect of the present invention provides a method comprising, in response to activation of a keypad located on a housing of a pointing device, transmitting a signal from the pointing device to a computing device via an interface, a signal indicating data to be displayed on a screen associated with the computing device.

A fourth aspect of the present invention provides a method comprising, in response to activation of a virtual keypad activation mechanism of a pointing device, transmitting a signal from the pointing device to a computing device via an interface, a signal indicating a command to display a virtual keypad on a screen associated with the computing device.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a general purpose computer, having a pointing device connected thereto.

FIG. 2 depicts a perspective view of a pointing device according to a first embodiment of the present invention is shown.

FIG. 3 shows a flowchart of an operation of the first embodiment of the pointing device of the present invention.

FIG. 4 depicts a perspective view of a pointing device according to a second embodiment of the present invention.

FIG. 5 shows a flowchart of an operation of the second embodiment of the pointing device of the present invention.

FIG. 6 depicts a perspective view of a pointing device according to a third embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

The term “computing device” herein encompasses a general purpose computer, a special purpose computer, a tablet computer, a telephone, a cellular phone, a smartphone, and any other digital computing device now known or hereafter developed, etc. In addition, the term “screen”, “display screen” or “display” as used herein can be any user interface.

In general, a pointing device, or “mouse” (used interchangeably herein), detects a direction and position of movement of the mouse, and transmits the coordinates to a computing device to control movement of a cursor or other pointer on a screen associated with the computing device. Keyboard technology allows a user to enter data, typically, in the form of alphanumeric and other symbols to a computing device.

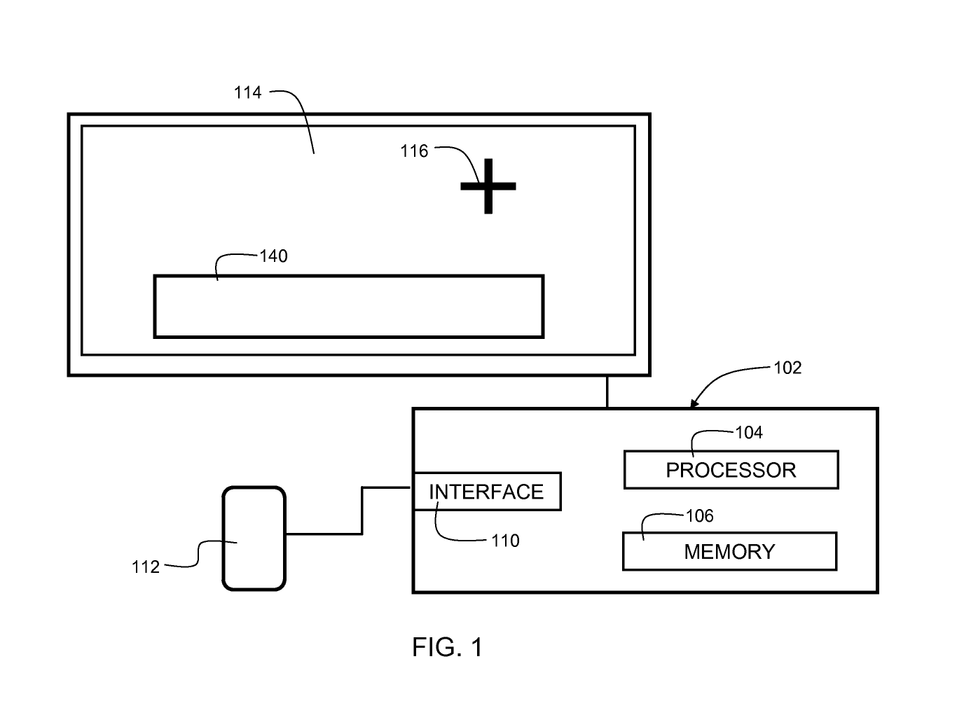

FIG. 1 shows a computing device 102. Typically, a computing device comprises a processor 104, and memory 106. The memory 106 may include a combination of random access memory (RAM), and read-only memory (ROM). Computing device 102 typically receives input from a user through an interface 110 from any of the pointing devices 200, 400, or 600 of the present invention, represented on FIG. 1, generally, as 112. When computing device 102 receives data transmitted from a keypad (or “keyboard”, used interchangeably therewith herein) or position detector from the pointing devices of the present invention, computing device 102 may display the data or a representation thereof on a screen 114.

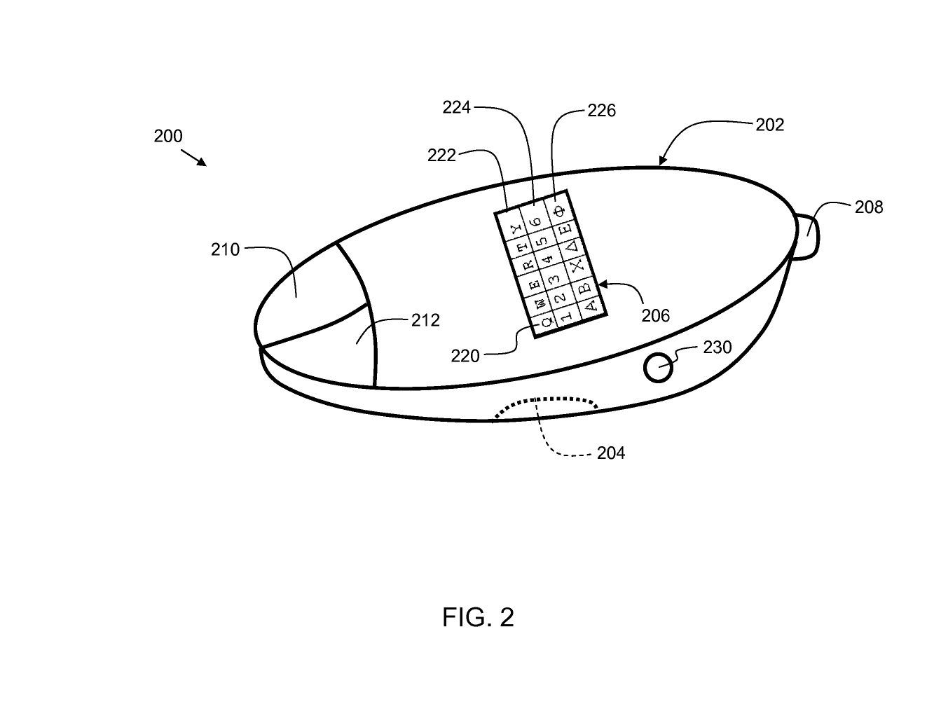

Referring to FIG. 2, a pointing device according to a first embodiment of the present invention is shown. Pointing device 200 typically comprises a housing 202, position detector 204, a keypad 206, an interface/communication mechanism 208, and function buttons 210 and 212.

Position and movement detector 204 (referred to herein as “position detector”) is typically provided for detecting the direction and distance of movement of the pointing device 200. When pointing device 200 is moved back and forth and from side to side, the coordinates of the position are detected by the position detector 204. The coordinates are transmitted to the computer (e.g., 102 of FIG. 1) through the interface 208, and a cursor (e.g. 116 on FIG. 1) can be moved on the screen (e.g., 114 on FIG. 1) associated with the computing device (e.g., 102 of FIG. 1).

The position detector 204 may be any suitable detection apparatus, such as a trackball apparatus, a ball type using a mouse ball, of an optical type using an optical sensor, laser sensor, or any other suitable detection technology now known or hereafter developed, etc.

The at least one function button is represented herein as function buttons 210 and 212. In practice, more or fewer function buttons may be included on the pointing device 200, and the invention is not limited to the two shown. In the present embodiment, the function buttons are shown on an upper surface of housing 202. In practice, the function button(s) can be situated on any suitable area of the pointing device 200 accessible to a user typically by his/her fingers. Function buttons 210 and 212 have the same function as the function buttons provided on a conventional mouse. For example, when the function buttons 210 and 212 are pressed, signals are transmitted to the computing device (e.g. 102 of FIG. 1) through the interface 208 and an operation in accordance with each function button can be performed on the computing device.

The keypad 206 includes an array of keys, e.g., 220. The keys 220 of keypad 206 may comprise button-like keys. Alternatively, the keypad 206 may be a screen wherein the keys 220 are touch-sensitive virtual keys. These keys may comprise alphanumeric symbols, e.g., arranged in a QWERTY keypad 222 and/or a numerals keypad 224, and/or a plurality of control keys 226. Keys 222 of the keypad 220 are configured and disposed to transmit a code via interface 208 to a computing device (e.g. 102 of FIG. 1).

The interface 208 transmits signals generated in the operation of the pointing device 200 to the computing device (e.g. 102 of FIG. 1). Interface 208 can be any suitable technology, for example, wired, wireless, and any technology now known or hereafter developed. More specifically, without limitation, the interface 208 can communicate via Universal Serial Bus (USB), Bluetooth, ZigBee, infrared, etc. Signals originating from the position detector 204, keypad 206, and function buttons 210 and 212, may be sent through the interface 208 to the computing device (e.g. 102 of FIG. 1) for processing.

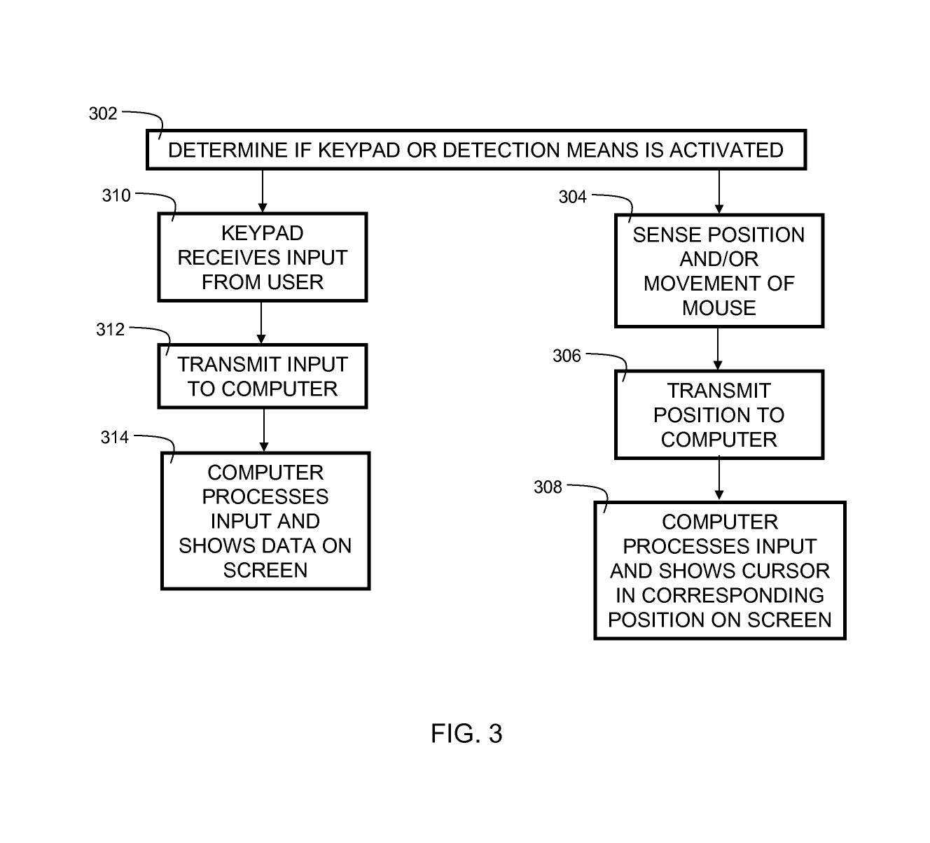

FIG. 3 shows a flowchart of the operation of pointing device 200. At 302, a determination is made as to whether the keypad 206 or position detector 204 is activated. In some embodiments of the invention, when one of the keypad or position detector is activated, the other of the keypad or position detector is deactivated and cannot accept input. Activation or deactivation can be accomplished by any mechanism, for example, a switch 230 of FIG. 2. In other embodiments, both keypad and position detector can be active simultaneously.

If at 302, it is determined that keypad 206 is activated, at step 304, position detector 204 senses position and movement of the pointing device 200. At 306, the pointing device 200 transmits positional data to the computing device (e.g., 102 of FIG. 1). The computing device 102 then processes the data, at 308, and accordingly, moves a cursor 116 or other pointer on a screen (e.g., 114 of FIG. 1) to a position corresponding to the positional data.

If, at 302, the determination is that the keypad 206 is activated, at 310, the keypad accepts input (alphanumeric and/or symbolic by a user's pressing of one or more of the keys). At 312, the keypad transmits the input as data to the computer (e.g., 102 of FIG. 1). The computer 102, at 314, then processes the data and displays the input on a screen (e.g., 114 of FIG. 1).

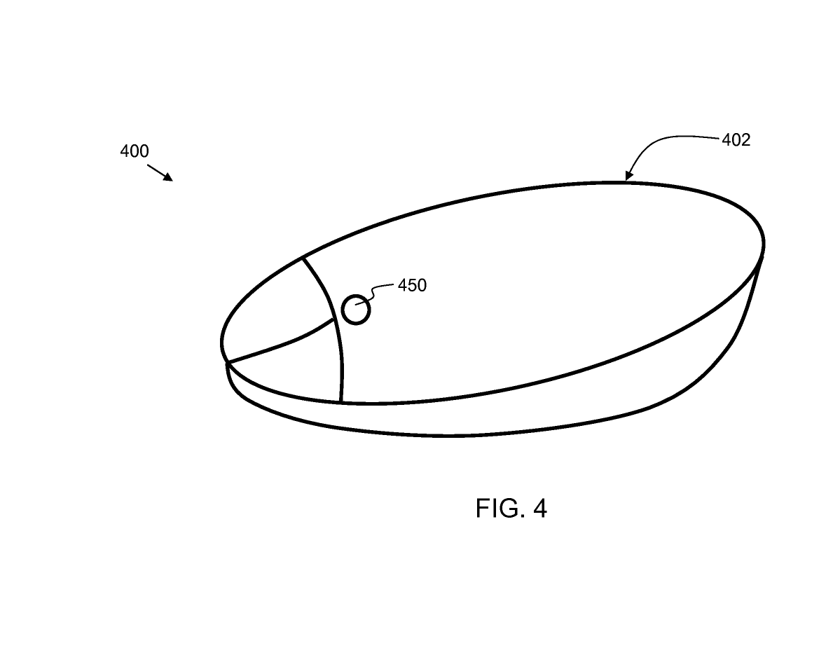

Referring to FIG. 4, a pointing device 400 according to a second embodiment of the present invention is shown. In the second embodiment, the pointing device 400 may comprise any or all of the components of pointing device 200, except that pointing device 400 comprises a virtual keypad activation mechanism for installing/accessing a virtual keypad program (rather than an integrated keyboard), i.e. initiating the display of a virtual keyboard on a screen (e.g., 114 of FIG. 1) of a computing device, such as a tablet. In some embodiments, the virtual keypad is provided by the operating system, or another program installed on the computing device. As shown herein, the mechanism may comprise a button 450 on housing 402. The button 450 is not limited to the position shown, but may be situated at any suitable position on housing 402 from which a user can access it. Additionally, the button 450 is not limited to configuration as a button, but may be any suitable device, for example, without limitation, a pressure sensor, etc. Alternatively, the virtual keypad activation mechanism may activate the virtual keypad in response to the operating system sensing the presence of the pointing device 400 on a USB port, or other interface.

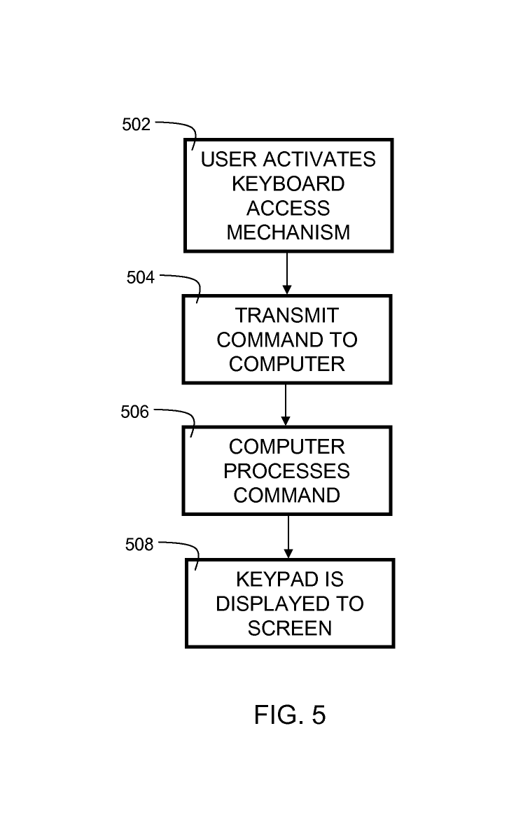

FIG. 5 shows a flowchart of an operation of the pointing device 400. In response to a user pressing the button 450 or sensing the presence of a pointing device 400 on an interface (e.g., 110 of FIG. 1), at 502, the pointing device 400 transmits a signal to a computing device (e.g., 102 of FIG. 1) indicating a command to display a virtual keypad (such as 140 of FIG. 1) on the display screen 114, at step 504. The computing device 102 receives and processes the signal, at 506, and displays the keypad 140 on the display screen 114, at 508. In some embodiments, the display screen 114 is a touch-sensitive screen so a user can then enter input via a keyboard to the computing device 102.

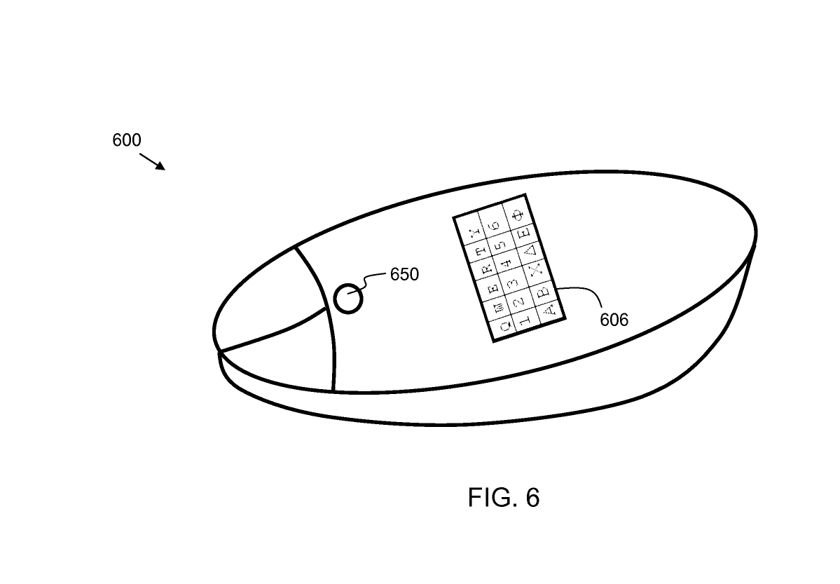

FIG. 6 shows a perspective view of a third embodiment of the invention. Point device 600 may comprise any and all components of either of pointing device 200 or 400. In this embodiment, pointing device 600 comprises both an integrated keypad 606 thereon and a virtual keypad activation mechanism 650. The keypad 606 and keypad activation mechanism 650 function substantially similarly to keypad 206 of FIG. 2 and keypad activation mechanism 450 of FIG. 4.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A pointing device, comprising:
a housing;
a position detector;
an interface; and
a keypad.

2. The pointing device of claim 1, wherein the keypad is integrated on the housing.

3. The pointing device of claim 1, wherein the interface is at least one of Bluetooth technology and USB technology.

4. The pointing device of claim 1, further comprising at least one function button.

5. The pointing device of claim 1, wherein in response to activation of the keypad, the position detector becomes deactivated.

6. The pointing device of claim 1, wherein in response to activation of the position detector, the keypad becomes deactivated.

7. The pointing device of claim 1, wherein the position detector comprises one of a trackball apparatus, optical sensor, and a laser sensor.

8. The pointing device of claim 1, further comprising a virtual keypad activation mechanism.

9. The pointing device of claim 8, wherein when the activation mechanism is activated, a signal is sent through the interface to a computer to display a virtual keypad on a screen.

10. The pointing device of claim 9, wherein the activation mechanism is a button and the activation is achieved through a user pressing the button.

11. The pointing device of claim 9, wherein the position detector controls a cursor on the screen.

12. The pointing device of claim 1, wherein the pointing device is a mouse.

13. The pointing device of claim 1, wherein the interface communicatively connects the pointing device to a computing device.

14. A pointing device, comprising:
a housing;
a position detector;
an interface; and
a virtual keypad activation mechanism.

15. The pointing device of claim 14, wherein when the activation mechanism is activated, a signal is sent through the interface to a computer to display a virtual keypad on a screen.

16. The pointing device of claim 14, wherein the activation mechanism is a button and activation is achieved through a user pressing the button.

17. The pointing device of claim 14, wherein the pointing device is a mouse.

18. The pointing device of claim 17, wherein the mouse controls a cursor on a screen.

19. A method comprising, in response to activation of a keypad located on a housing of a pointing device, transmitting a signal from the pointing device to a computing device via an interface, the signal indicating data to be displayed on a screen associated with the computing device.

20. The method of claim 19, wherein the pointing device is a mouse.
